(19) United States
(12) Patent Application Publication
(10) Pub. No.: US 2012/0315211 A1
(43) Pub. Date: Dec. 13, 2012

(54) Acoustic Processing of Carbon and Graphite Particulates

(75) Inventor: Naresh Mahamuni, Nevada City, CA (US)

(73) Assignee: IMPULSE DEVICES INC., Grass Valley, CA (US)

(21) Appl. No.: 13/491,083

(22) Filed: Jun. 7, 2012

Related U.S. Application Data
(60) Provisional application No. 61/494,395, filed on Jun. 7, 2011.

(51) Int. Cl. B01J 3/08

(52) U.S. Cl. 423/446

(57) ABSTRACT

The present disclosure is directed to the use of high-intensity acoustic cavitation, including carried out under pressure in cavitation chambers to convert graphite powder or similar carbon based substances into low-cost, industrial diamonds. In some aspects, this can facilitate the development of an economical manufacturing process for the production of superior-quality, industrial-grade diamond materials.

### RELATED APPLICATIONS

This application is a non-provisional deriving from and claiming the full benefit and priority of U.S. Provisional Application No. 61/494,395, filed on Jun. 7, 2011, entitled “System and Method for Processing Carbon Based, Graphite and Similar Materials,” which is hereby incorporated by reference.

### TECHNICAL FIELD

The present disclosure relates to processing carbon-based materials, especially in particulate form, including processing of graphite particles, which may be used for example to yield an industrial diamond product.

### BACKGROUND

The allotropic transformation of graphite powder to diamonds requires temperatures of between 900 and 1,300° C. and pressures between 45 and 60 kilobars. Conventional methods of producing these conditions are expensive, use tremendous amounts of energy, and often require the use of toxic and/or dangerous materials. The most common current methods are described below.

In using high-pressure/high-temperature (HPHT), this requires costly equipment and tremendous amounts of energy to create the heat and pressure required for graphite-to-diamond conversion. This method produces high-quality diamonds; suitable for mass production processes.

In using chemical vapor deposition (CVD), this grows diamonds from a hydrocarbon gas mixture; does not require high pressures but does require high temperatures. This method is not well suited for mass production.

In using explosive detonation, this forms structurally imperfect diamonds of approximate diameter of 5 nanometers. This is time-consuming and requires use of dangerous explosives and toxic chemicals and is mainly used in China, Russia, and Belarus.

Some work has been done to explore acoustic methods in their context. For example, E. M. Galimov theorized that natural diamonds might be synthesized under cavitation conditions in a fast moving magmatic melt. In 2004, his group purported to synthesize diamonds by inducing hydrodynamic cavitation in a liquid hydrocarbon, benzene. In this approach, Galimov et al produced cavitation bubbles by flowing benzene rapidly through a nozzle. The team collapsed the bubbles by detonating explosive charges, producing pressures of approximately 1.2 to 1.5 kilobars to transform the carbon molecules contained within the collapsing bubble into diamonds. Even with these extreme pressures, the resulting diamonds did not exceed more than a few nanometers in diameter, severely limiting their use in industrial applications.

H. G Flynn described the possibility of converting graphite into diamonds using acoustic cavitation. Since that time, some progress has been made in numerical simulation and experimental techniques, giving scientists an even more realistic understanding of the extreme conditions near collapsing bubbles. In 2008, A. K. Khachatryan et al. purported to use ultrasonic cavitation of graphite particles in various organic liquid media to synthesize diamond crystals. Although his experiment sought to use cavitation bubbles to convert graphite into diamonds, the researchers were unable to produce diamonds larger than approximately 6-9 micrometers (μm). Therefore, an effective and economical way to create useful diamond products has not been available using traditional methods.

### SUMMARY

The present application describes the use of high-intensity acoustic cavitation, including carried out under pressure in cavitation chambers (e.g., Extreme Acoustic Cavitation™ technology from Impulse Devices, Inc., Grass Valley, Calif., USA) to convert graphite powder or similar carbon based substances into low-cost, industrial diamonds. This may promote the development of a low-cost, new manufacturing process for the production of superior-quality, industrial-grade diamonds.

In some embodiments, this process would be characterized by relatively low energy inputs, much lower costs, smaller system footprints, and a greatly reduced impact on the environment. This innovation can help the industrial diamond manufacturing industry by providing a new processing technique and system for a material used in structural applications.

### BRIEF DESCRIPTION OF THE DRAWINGS

For a fuller understanding of the nature and advantages of the present concepts, reference is be made to the following detailed description of preferred embodiments and in connection with the accompanying drawings, in which:

FIG. 1 illustrates an exemplary cavitation system according to the present disclosure;

FIG. 2 illustrates an exemplary embodiment of acoustic cavitation chambers or resonators that take an incoming fluid or mixture through an inlet port and cavitate the same before discharging the fluids or mixtures through an outlet port and where the general direction of fluid flow is parallel to a long axis of symmetry of the chamber;

FIG. 3 illustrates an exemplary cross-section of an acoustic resonator with an acoustic reaction chamber therein; and

FIG. 4 illustrates an exemplary cavitation reactor within a resonator, showing two fluid circuits.

### DETAILED DESCRIPTION

High intensity cavitation, e.g., Extreme Acoustic Cavitation™ from Impulse Devices, Inc. and related techniques as described herein and in applications by the present inventors and assignee—including steps of the formation and collapse of bubbles—or cavities—within liquid media at very high static pressures through exposure of the liquid to rapid changes in acoustic pressure is used to achieve such results. The bubbles created by the pressure differentials first grow in size and then rapidly collapse, producing high temperatures (>30000° C.) and pressures (>10,000 bars) within the collapsing gas cavity, a shock wave, turbulence at microscopic levels, and, quite often, a flash of visible light (sonoluminescence).

In some embodiments, extreme temperatures and pressures associated with high intensity cavitation are sufficient to convert graphite powder into industrial diamonds. The present processes may in some embodiments produce micron-sized (1-10 μm) industrial-grade diamonds, and, some as large as 100 μm.

In some embodiments, high intensity cavitation is used within specialized, high-pressure spherical resonators, in which the liquid media are maintained at hydrostatic pressures of up to than 1 kilobar—higher than achieved by other methods. By contrast, conventional acoustic cavitation technologies are typically only capable of producing consistent, reliable cavitation at pressures of one to three bars.

Bubble collapse at such extreme hydrostatic pressures is violent, producing incredible extremes of pressure and temperature at the collapsing bubble's super-concentrated core. At a hydrostatic pressure within a spherical resonator of only 100 bars, or a pressure of approximately 1000 bars using a hydrophone positioned 1 cm from a collapsing bubble. Because pressure decreases as 1/r, where r is the distance from the collapsed bubble's center, the pressure near the super-concentrated core of the collapsed bubble must reach very high levels. Numerical simulations confirm temperatures as high as 1100K and pressures above 300,000 bars in a 100 μm radius near the region of the collapsing bubble. Depending upon the liquid medium and the applied static pressure within the resonator, at the moment of collapse the temperature and pressure of the gas at the center of the cavities are believed to reach greater than 100,000 K and 1,000,000 bars. In some cases, these conditions allow converting powdered graphite into industrial diamonds. In one example, it is possible to achieve cavitation at extremely high hydrostatic pressures by using spherical resonators. It must be clear that the present examples offer illustrations of the present concepts and are not intended as limiting or restricting of the general scope of discussion of the systems and methods described herein. So for example, wherever dimensions or quantitative descriptions are provided, these are given as explanatory and exemplary embodiments only. Those skilled in the art would appreciate extensions to other examples and equivalents and derivatives that are comprehended by this discussion and appended claims.

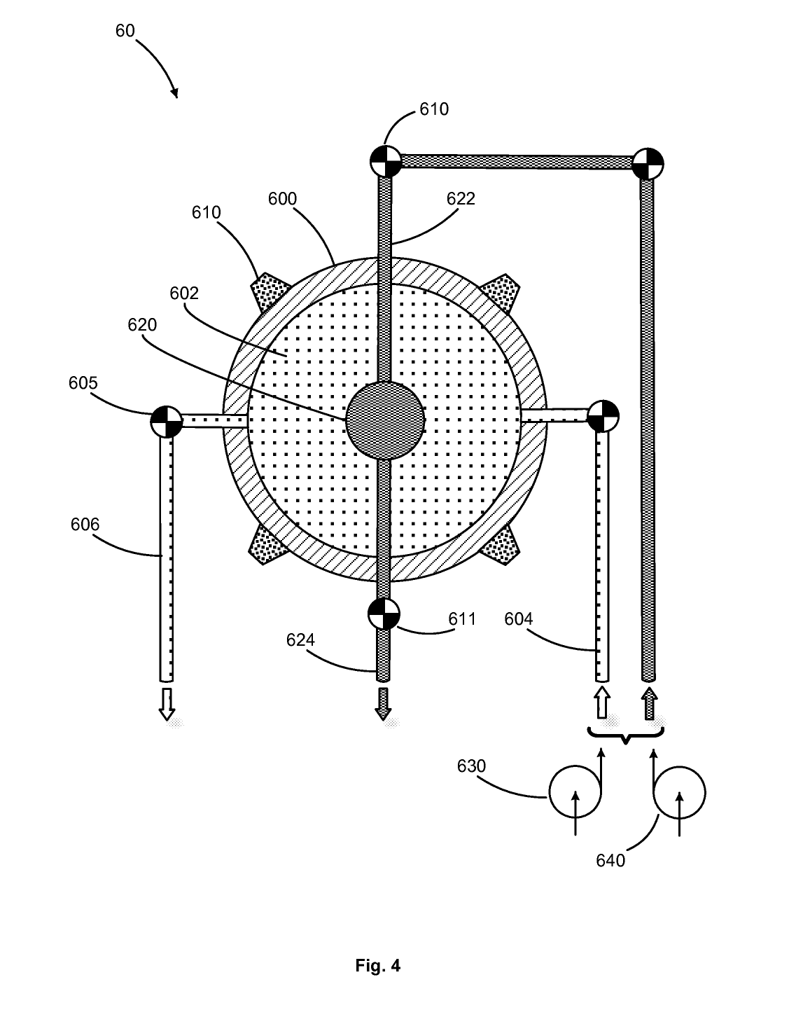

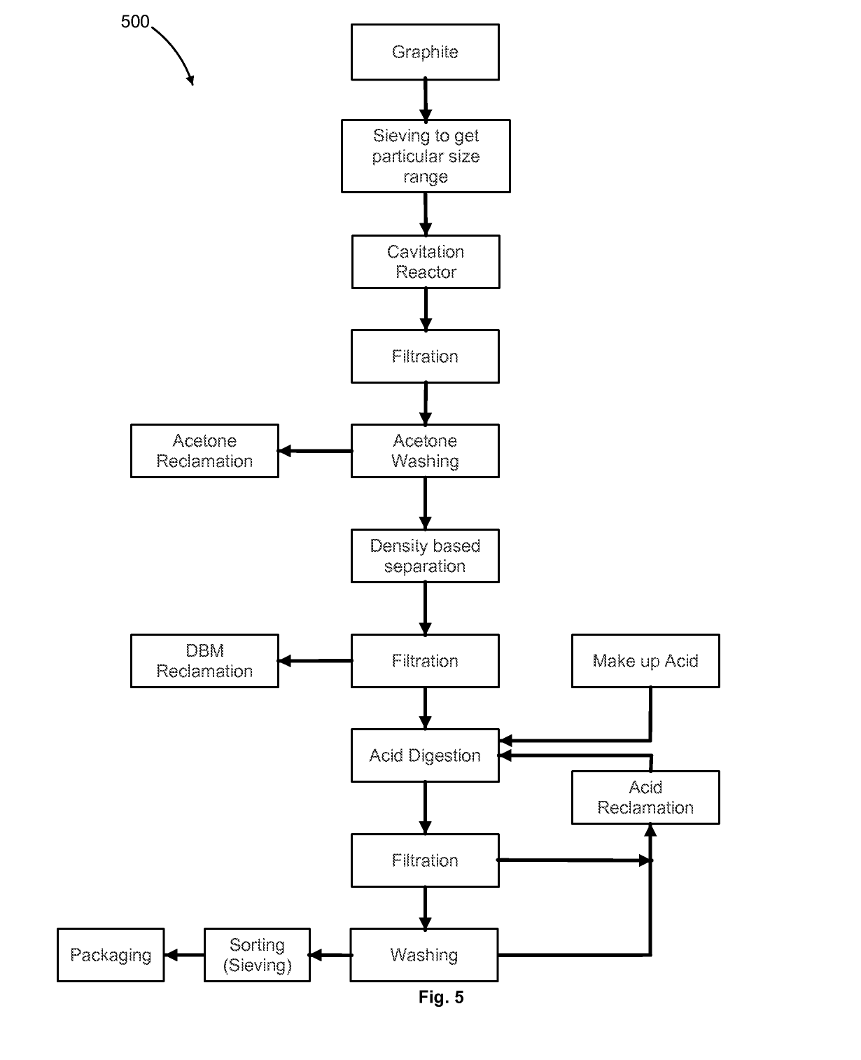

The invention benefits from high-static-pressure spherical resonators (6- and 9.5-inch diameters), various acoustic drivers, acoustically transparent balloon insets (see FIGS. 3 and 4), high-speed cameras, fiber-optic probes, and PVDF hydrophones.

To increase the hydrostatic pressure within the resonators, one embodiment employs pumps in selected liquid media, including, for the proposed project, polyphenol ether (PPE), water, and a proprietary liquid gallium blend. Once the static pressure reaches the desired level—typically several hundred bars—acoustic drivers at the periphery of the sphere propagate low-intensity ultrasound (e.g., 1-5 bar) through the liquid media, concentrating the acoustic energy into a high-energy-density (e.g., about 1,000 bar) region at the center of the sphere. In some embodiments, this operation requires minimal energy input (e.g., 50-200 W).

Several objects and results include synthesizing industrial diamonds from graphite particles suspended in polyphenol ether (PPE), synthesizing diamonds from graphite particles suspended in water and synthesizing diamonds from graphite particles suspended in liquid gallium. In some or all of these applications it is possible to determine or estimate a maximum concentration of graphite powder in the selected cavitation medium that will still allow reliable, prolonged (e.g., 30-60 minutes) cavitation at elevated static pressures (e.g., 50-300 bars)

Graphite and diamonds are two allotropic forms of carbon in the same (solid) phase. The spatial arrangement of the carbon atoms can differ. In diamonds the carbon atoms are arranged in a tetrahedral lattice; in graphite, the carbon atoms are bonded in sheets of a hexagonal lattice. These stable forms of carbon have the same chemical composition and are in the same solid phase.

Some embodiments introduce graphite particles (100-200 μm in diameter) into three different cavitation media of varying concentrations (5%-25% range) and cavitate the mixtures at elevated static pressure (50 to 300 bar) for 30-60 minutes within a selected acoustic resonator. The first liquid cavitation medium will be an isomeric mixture (homogeneous mixture of compounds that vary in structure but share the same chemical formula) of five- and six-ring polyphenyl ethers (PPE). The other two selected media are water and liquid gallium. Impulse will contain the selected media within acoustically transparent balloons (FIGS. 3 and 4) inside the resonators. These balloons enable Impulse to minimize the use of PPE (˜$16,000/gal) and liquid gallium, both of which are extremely expensive.

As discussed herein, Impulse's high-pressure spherical resonators concentrate tremendous amounts of acoustic energy in the center of the spherical resonators. Impulse plans to initiate bubble clusters by inducing the spontaneous nucleation of a single bubble near the center of the resonator that collapses and reemerges from the first collapse as a cluster of bubbles. This cycle will continue through subsequent cycles, adding more and more bubbles to the bubble cluster.

Reference is made to any of a number of published and issued patent applications by the present inventors and assignee, incorporated herein by reference, in which an interior cavitation volume set within a larger acoustic resonator, is used to contain the substance being acted on. Specifically, but not by way of limitation, the following disclosures, incorporated herein by reference, contain descriptions of systems and methods for using them that can benefit the present description and provide details of designs and applications useful for various instances of the present invention. These include Impulse Devices, Inc., U.S. patent application Ser. No. 13/294,574, entitled “Pressurized Acoustic Resonator with Fluid Flow-Through Feature;” and No. 61/270,216, entitled “Liquid Metal Cavitation System;” and No. 13/075,355, entitled “Apparatus and Method for Cavitation in Concentric Chambers,” all of which are hereby incorporated by reference.

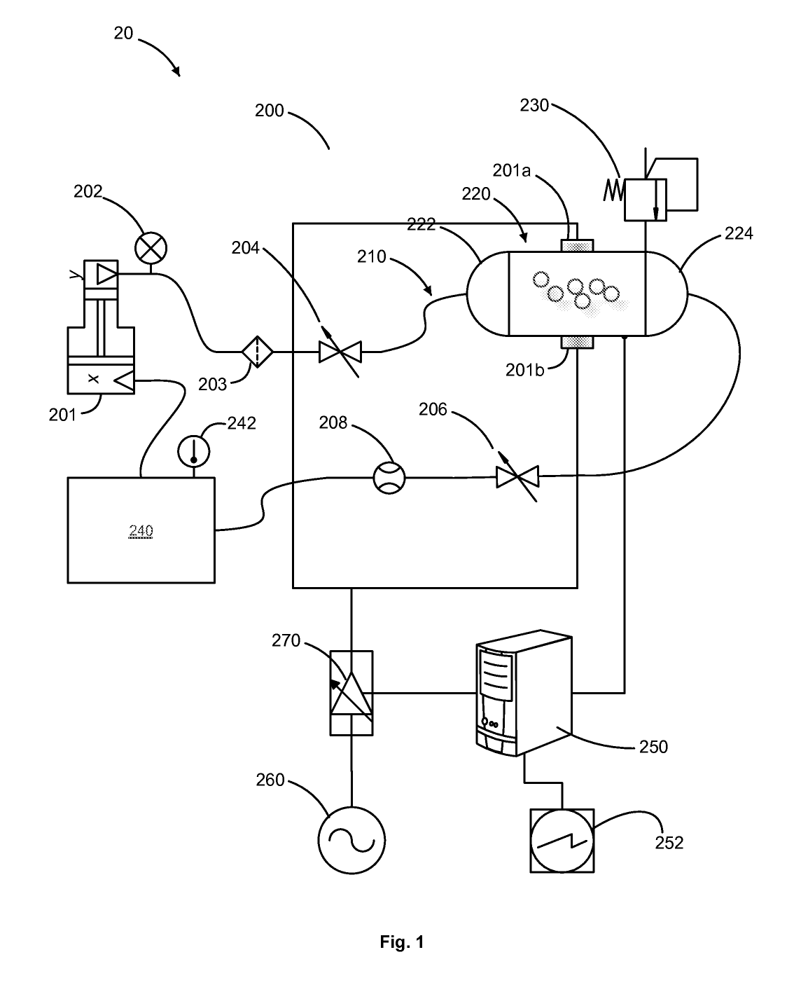

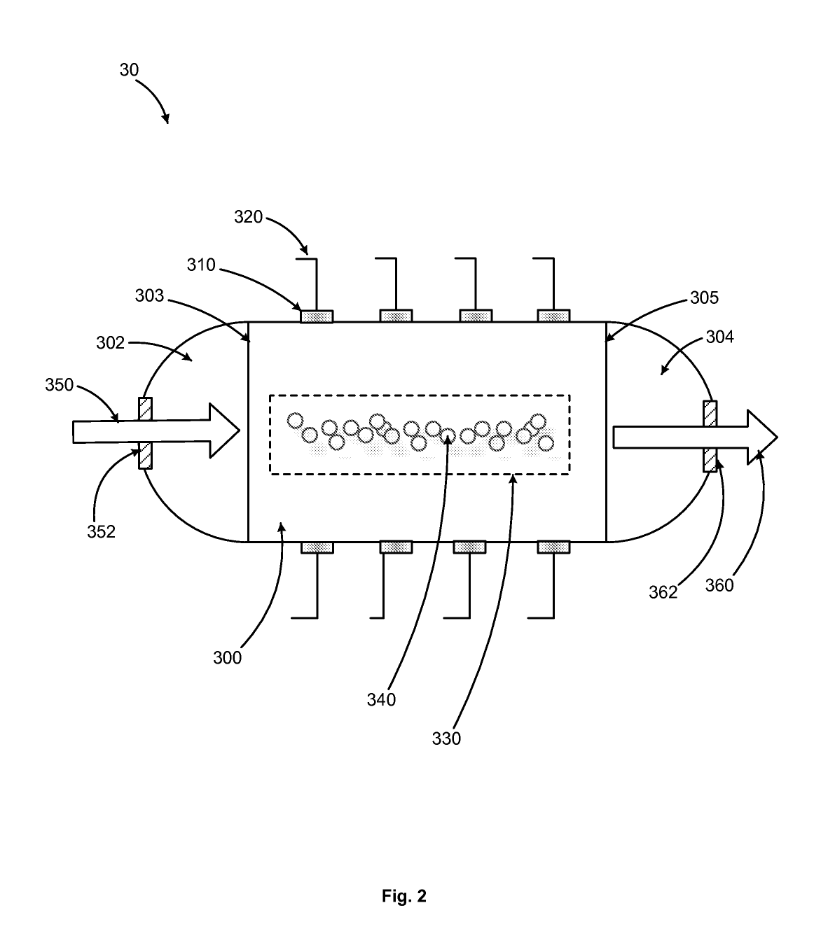

FIG. 1 illustrates an exemplary acoustic resonator and cavitation system 20. The system includes an electrical circuit 200 for driving the acoustic drivers 201a and 201b (which can be generalized to a plurality of acoustic drivers). The circuit is controlled by a controller or control processor or control computer 250. A signal generator or waveform generator 260 provides a signal that is amplified by amplifier 270, which is in turn computer-controlled by computer or processor 250. As mentioned earlier, the driving output of amplifier 270 provides the electrical stimulus to cause transduction within transducers 201a, b, which in turn cause acoustical field generation within resonator chamber 220.

The heavier lines of FIG. 1 represent a fluid circuit that circulates a fluid to be acoustically cavitated in resonator or chamber 220. The resonator 220 comprises a first end cap or end bell 222 at a first end thereof, and a second end cap or end bell 224 at a second end thereof. Said first and second ends of resonator 220 being substantially at opposite ends of said resonator 220 in some embodiments. Generally, a fluid is flowed in resonator 220, sometimes under static pressure, and said fluid may be cavitated by acoustic transducers 201a, b. As will be described further, the relative placement of the transducers and the fluid inlet and outlet ports in the system with respect to the acoustic field within the resonator 220 is arranged to achieve a desired outcome in processing the flowing pressurized fluid and/or materials suspended or dissolved therein.

The fluid circuit includes a fluid driver (e.g., a pump such as a rotary or reciprocating pump) 201. The pump 201 drives the fluid against the head loss in the fluid circuit portion of cavitation system 20. A pressure gauge 202 may be installed at a useful location downstream of pump 201 to monitor the pressure at its highest value downstream of pump 201. A filter 203 may be used inline with the flowing fluid to trap any impurities or dirt in the fluid.

A solenoid or gate valve 204 may be used to secure the fluid flow in some cases or to isolate the resonator upstream of the resonator 220. A second solenoid valve 206 is used to secure flow of the fluid or to isolate the resonator 220 in cooperation with valve 204.

Relief value 230 may be provided as a safety mechanism to relieve fluid from the system if the pressure of said fluid exceeds a pre-determined threshold. For example, the relief valve may be set to discharge fluid in a controlled way if the pressure within resonator 220 approaches a value that could jeopardize the integrity of the resonator or other system components.

Fluid flow rate meter 208 may be used to sense and provide an indication of the rate of fluid flow (e.g., in cubic centimeters per second) through the fluid system. Because the fluid is generally incompressible, the fluid flow rate in the outlet portion of the system (as pictured) is substantially the same as the flow rate at the inlet to resonator 220.

A fluid holding, storage, surge or expansion tank or reservoir 240 is provided to contain an adequate amount of fluid and mediate any volumetric or pressure surges in the system. A temperature sensor (thermometer) 242 is used to provide an indication of the temperature of the fluid in the system.

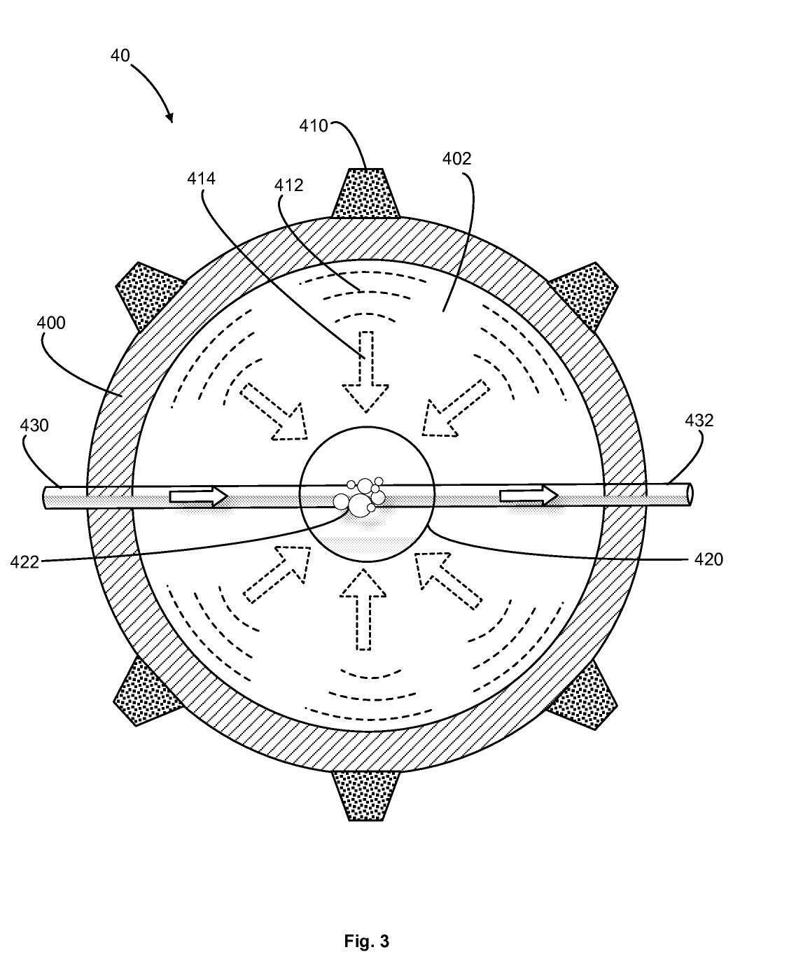

FIG. 2 illustrates another embodiment 30 or configuration of the present cavitation chambers. Liquid fluid 350 flows into an inlet volume 302 through an inlet port 352. A main cavitation volume 300 receives said incoming liquid 350 from the inlet volume 302. The main cavitation volume 300 of the chamber 30 may have a cylindrical shape and a generally circular cross section perpendicular to its cylindrical axis. The flow of liquid is generally to the right in FIG. 2 and qualitatively flowing substantially parallel to a cylindrical axial axis of symmetry of chamber 30, although it is to be understood that the flow may follow locally-variable paths and be subjected to turbulent movement at a local scale as well. The liquid 360 exits the chamber by flowing through exit volume 304 and out of the chamber from outlet port 362. The main cavitation volume 300 and the inlet and outlet volumes 302 and 304 may be formed as a single unit. Alternatively the three volumes may be formed by joining the inlet and outlet volumes 302, 304 to the central main volume 300 at joining locations 303 and 305. Joining locations 303 and 305 may be made by mechanically or otherwise coupling the various sections of cavitation chamber 30. These may be joined or coupled by a threaded or bolted mechanism, or by braising or welding, depending on the application so as to form a liquid seal to contain the liquid of interest within cavitation chamber 30.

As described earlier, numerous components may be connected to the cavitation chamber 30 forming a cavitation system having fluid and electrical parts, which are not all shown in FIG. 2 for simplicity. In addition, various coatings and surface treatments may be applied to the interior surfaces of the liquid-containing volumes of cavitation chamber 30 as needed to allow improved wetting of said surfaces for example. As discussed before, other materials, reactants, liquids, gases, or solids may be injected into or mixed with the primary cavitating fluid so that cavitation effects can operate on said mixed, dissolved, or entrained materials.

Cavitation chamber of FIG. 2 may be coupled to a plurality of acoustic drivers 310, which are in turn powered as discussed above by corresponding driving power connections 320. The plurality of acoustic drivers 310 may be driven with a common (shared) driving signal through connections 320 to each of the respective drivers or transducers 310, or each driver or transducer 310 may receive a unique and respective driving signal, or groups of drivers or transducers 310 may be grouped and each group thereof driven as a whole using a same or similar driving signal. In operation, piezo-electric ultrasound transducer elements 310 may be driven in a way to cause a desired cavitation condition within the liquid contained in or moving through volume 300 of the cavitation chamber 30. Of course, the cavitation may take place in a cavitation zone 330 that can include some or all of the interior volume of portion 300 of said chamber, depending on the design, driving and operational conditions. A plurality of cavitation bubbles 340, voids, or bubble clouds or bubble groups may be caused to form in cavitation zone 330 of chamber 30. The bubbles 330 may be convected or move with a fluid flow as the fluid passes from inlet port 352 to outlet port 362 of chamber 30.

In some embodiments, cavitation zone 330 extends to about a certain radius about the axial axis of the cylindrical cavitation chamber, and may extend in length to a certain length along said axis of the chamber. While not necessarily exactly cylindrical in shape, the cavitation zone formed hereby may take a general shape if averaged over time that resembles a cylindrical volume or a capsule shaped volume or elongated egg volume within the cavitation chamber's overall fillable volume. In some specific embodiments, the cavitation zone 330 is greater in volume than five percent (5%) of the volume of the cavitation chamber. In other embodiments, the cavitation zone has a volume greater than ten percent (10%) of the volume of the cavitation chamber. In yet other embodiments the cavitation zone has a volume greater than twenty five percent (25%), fifty percent (50%), or even greater than seventy five percent (75%) of the volume of the cavitation chamber. Finally, the cavitation zone may be made to include greater than ninety percent (90%), or substantially the entirety of the volume of the cavitation chamber.

For example, a small spherical container having separate fluid conduits in and out thereof, disposed inside a larger resonator chamber may be used to concentrate and improve the effectiveness of the system. This allows the graphite powder to be located close to the zones of maximum acoustic activity and cavitation regions of the larger resonator. In an example, a polymer (e.g., nylon, plastic, rubber) balloon, bladder or spherical cavitation reactor of a few centimeters in diameter holds the graphite raw substance and cavitation fluid within a larger spherical resonator chamber of several inches diameter, said inner cavitation chamber being at or near the center of the larger resonator and/or at a location of maximum acoustic field intensity.

FIG. 3 illustrates an exemplary cross-section of an acoustic resonator with an acoustic reaction chamber therein. The acoustic resonator system 40 comprises a resonator shell 400 as described earlier, which may consist of a spherical or other three-dimensional volume having a solid material composition. In some embodiments, the resonator system 40 comprises a substantially spherical stainless steel resonator shell 400.

A plurality of acoustic or ultrasonic energy sources 410 are disposed on and about an external surface or resonator shell 400. The acoustic transducers 410 may be driven individually or collectively or in groups so as to emit an acoustic energy field 412, which propagates inwardly as shown by arrows 414 towards a central volume of the resonator system 40.

A reactor or a reaction chamber 420 is located within the interior of resonator shell 400 and in some embodiments at or near a central volume of the resonator system 40. The reactor 20 provides a volume which may be filled with a material of interest and which may include a zone of cavitation 420 that acts on the material, fluid, or other substances injected in the reaction chamber 420. As described above, a material onto which it is desired that the acoustic field act may be injected into the reactor 420 through an inlet port 430 and following acoustic reaction at cavitation zone 422, the material may be passed out of the resonator system through outlet port 432.

In the example of a spherical or substantially spherical system 40, the resonator shell 400 and spherical reaction chamber 420 may be substantially concentric. That is, both the resonator shell 400 and the reaction chamber 420 within the resonator may be spherical in shape and may have the same or approximately the same centers. In this example, acoustic energy 412 will propagate from transducers 410 through shell 400 and inwardly 414 towards the surface of reactor 420. The reactor 420 is manufactured of a material, which is acoustically transparent or substantially permissive to ultrasound energy 412 to allow the ultrasound energy to travel through the walls of reactor 420, and in to the material contained within reactor 420. In some embodiments where cavitation is desired, the acoustic energy 412 propagates inwardly 414 through the walls of reactor 420 and inwardly towards cavitation zone 422 where a desired cavitation transformation or reaction takes place on the material contained within reactor 420.

FIG. 4 illustrates an exemplary fluid circuit for use with a preferred embodiment of the present cavitation reactor within acoustic resonator system 60. As described before, a resonator 60 including a resonator shell 600 contains within it a cavitation reactor 620. Ultrasonic transducers 610 may be coupled to the external surface of resonator shell 600, and may be disposed in a plurality of ways as desired to achieve an acoustic field within the interior volume 602 of resonator 60.

A first fluid is disposed within interior volume 602 of resonator 60, and may pass into the resonator through a fluid port in shell 600 and out of an output port of shell 600. In the exemplary embodiment shown, the inlet port is provided in fluid line 604 and the output port is provided in fluid line 606. Shut off valves may be disposed in each or any of the fluid lines as appropriate for a given application.

A second fluid or a material contained within a fluid may be passed into an out of reactor 620. In the embodiment shown, a fluid shut off valve 610 is located in the inlet line 622 of the second fluid, and a separate shut off valve 611 is positioned at the outlet of the second fluid line 624.

Fluid pressure sources such as pumps may be used to drive each of the first and the second fluid through their respectively fluid circuits. For example, a first pump 630 may be used to drive the first fluid into and then out of the interior volume of acoustic resonator 60. A second pump 640 may be used to drive the second fluid through the cavitation reactor 620.

It can be seen that a pressure differential between the first and second fluids within the acoustic resonator shell 600 and the cavitation reactor 620, respectively, may result in a stress on the walls of the cavitation reactor 620. This stress may be detrimental to the system or may cause a rupture in the walls of the reactor 620 or the fluid circuit lines passing through the resonator 600. Therefore, in some embodiments, the output pressure of first and second pumps 630 and 640 may be regulated so as to maintain a same static pressure within the interior of resonator shell 600 and the interior of cavitation reactor 620.

In yet other embodiments, a single pump or pressure source may be used to pressurize both the resonator volume 602 as well as the interior of the cavitation reactor 620 so as to avoid any imbalance in static fluid pressure within these two volumes. Note that pressurizing one or both fluids according to the above embodiments may be accomplished through use of any number of known fluid pressure sources, including centrifugal pumps, rotary pumps, screw pumps, positive displacement pumps, proportioning pumps, reciprocating pumps, pistons, gas pressure loading reservoirs or other means. By having a mutual or shared source of pressure to load the static pressure of the fluids within the resonator volume 602 and within the cavitation reactor 620, it is possible to automatically balance the pressure in these two volumes and avoid any differential pressure form being applied to the walls of cavitation reactor 620. This can be especially useful in some embodiments where the walls of the reactor 620 are thin or made of a material that cannot withstand substantial negative or positive differential pressures.

By proper placement and use of shut off valves, for example 605, 610 and 611, it is possible to halt or interrupt the flow of one or more of the fluids within the system 60. As an example, the second fluid within the reaction chamber 620 may be loaded therein and then the outlet valve 611 may be shut trapping the second fluid in the reaction chamber line, while a desired cavitation reaction takes place within reactor 620. Similarly, the first pump 630 may apply a pressure so as to introduce the first fluid into resonator volume 602 while outlet valve 605 is shut so as to achieve a desired pressure within volume 602. However, in other embodiments cavitation through ultrasonic fields generated by transducers 610 is allowed to take place within reactor 620 while the second fluid dynamically flows through the reactor 620 by passing from its inlet valve 610 and out its exit valve 611.

In some embodiments, the relative or absolute sizes (e.g., diameters) of the cavitation reactor chamber 620 and the resonator shell 600 may be designed so that their walls lie at optimum locations with respect to the acoustic fields therein. For example, the resonator 600 and acoustic sources 610 may generate and hold an acoustic field having nodes and anti-nodes in volume 602. The walls of reactor 620 may be dimensioned and located to be substantially at a node of the acoustic field in resonator 600. In this way, no movement or minimum fluid velocity may be achieved at or near the walls of reactor 620, therefore placing no or minimum load on the walls of the reactor 620.

When a single bubble collapses, it produces a shock wave. Although shock wave pressure decreases with distance from the bubble, pressure still remains very high within a few millimeters from the bubble. The width of the high-pressure area of the wave itself is approximately 0.5 mm and larger than the graphite particles themselves (0.1 to 0.2 mm). In some embodiments, the high-pressure region will encompass graphite particles within several millimeters of the bubble.

This effect is magnified in bubble clusters, which produce stronger and more numerous shock waves than a single bubble. Measurements with the fiber-optic probe hydrophone (FOPH) showed pressures on the order of 1 kilobar at approximately 1 centimeter from the collapsing bubbles. As the pressure decreases at least as 1/r, where r is the distance from the bubble, the FOPH measurements show that the pressure in the vicinity of the bubble is more than sufficient to convert graphite powder into diamonds.

More precise data on pressure and temperature distribution is obtained from the numerical calculations using computer codes, a 1-dimensional radiation hydrodynamics code developed to simulate laboratory experiments on dense plasmas driven by intense sources of energy. These simulations predict temperatures above 1100° K and pressures above 300 kilobar in 100 μm radius region near the bubble, indicating a strong likelihood that the graphite particles encompassed by the high-pressure regions of the bubble cluster will indeed convert into diamonds.

After completion of cavitation, select samples for each of the three media, choosing the highest concentration of graphite that still produces reliable, and prolonged (30-60 minutes) cavitation in each liquid medium at the highest static pressure. Impulse will filter the samples with a very fine mesh and carry out the following tests. Some embodiments carry out the tests in order: X-ray diffraction, Raman spectroscopy, and scanning electron microscopy (SEM). But this is not required. In combination, these tests confirm the presence or absence of diamonds in the samples to a 99 percent degree of accuracy.

The following outlines some steps of a process for making diamond substance, for example in particulate useful form, from particles of graphite or similar carbon-based materials. This example is, again, only given for illustrative purposes. The steps described can be supplemented with other steps, variations on these steps, equivalent substitutes for the quantitative aspects therein, or some steps can be deleted or rearranged from the order in which they are given below.

An operator prepares a cavitation station for processing the carbon based substance. This includes steps to gather and prepare the physical equipment needed to cavitate PPE and select PPE/graphite mixtures in a 6″ Impulse Devices, Inc. spherical resonator and the isolated inner cavitation zone (ICZ) of a 9.5″ spherical resonator. More specifically, the following acts could be performed in support of the present method in some embodiments.

Prepare a 6″ to 9.5″ diameter resonator and ICZ system; clean resonators and ICZ system; prepare resonator stands and valves/tubing for both assemblies; clean all valves and other plumbing; install resonators on stands; assemble resonator, ICZ system, and required plumbing (e.g., on optical table); leak-test the fluid systems; install the piezoelectric acoustic drivers for the resonators.

The resonators may then be filled with a cavitation fluid and the acoustic and mechanical performance thereof can be tested. The test particles may be introduced into the cavitation chamber as a separate act or pre-mixed with the cavitation liquid material at the time of or prior to introducing the same into the cavitation chamber. The concentration or amount of graphite in the cavitation liquid is determined and optimized. In some examples, 1% to 10% graphite concentration is achieved. In specific examples, about 5% graphite concentration is achieved. In other embodiments, the graphite concentration is up to 25% or another value as suited for a given application.

In some or all embodiments, the system may be pressurize to a determined static pressure and cavitation may be carried out at this static pressure value (e.g., twice atmospheric pressure, up to 50 bars, up to 100 bars, etc.). In an embodiment, the interior of the resonator chamber and/or cavitation reactor is pressurized to a range of 2000 psi to 5000 psi. In a specific instance, this pressure may be about 4500 psi.

A plurality of acoustic drivers may be coupled to the resonator chamber walls, and in some embodiments these may be piezo electric transducers, PZTs, acoustic horns, pill transducers, or other types. The transducers are driven according to an electrical driving signal having some frequency and amplitude characteristics and waveform. In an embodiment, the power used to drive the transducers (e.g., from an amplifier) is about 1 kilowatt, but, again, this is merely an example for the sake of illustration, and those skilled in the art can design many configurations of resonators, transducer assemblies and auxiliary components along the lines taught by this disclosure and covered by the present claims.

The pressure may continue to be raised incrementally using a fluid pressure control system, e.g. a pump, monitoring the static pressure with a pressure gauge or sensor. In some embodiments, the pressure is raised to around 300 bar or above, and cavitation is achieved at elevated pressure. Cavitation is continued until a desired result or pre-determined time or other criterion or criteria are achieved. For example, the system may operate at a desired frequency and acoustic intensity and static pressure for a period of 30 to 60 minutes, depending on the batch or flow-through rate of introduction of raw substances into the system.

In an example, the central driving frequency of the acoustic transducer elements generating the ultrasonic field in a resonator is between 20 kHz and 50 kHz. In a specific embodiment, the center frequency is about 26 kHz. In another example, it is about 33 kHz, which in part depends on the dimensions and shape of the resonator. Note that those skilled in the art would appreciate that resonators of this kind can be non-spherical (e.g., cylindrical, or otherwise).

Following treatment, filter a mixture removed from the system through a fine filter, e.g., a 3μ filter mesh, Mott Corporation, to separate product particulates, reserve particulates for analysis and PPE fluid for subsequent testing.

The materials may be separated (diamond product from raw and other substances) using a step of density separation using a fluid (e.g., an oil) so that the products of the cavitation step are separated into ones that float on the oil and ones that sediment or sink or do not float thereon. This way it is easier to extract the desired resulting product from the system. In a specific example for the purpose of illustration, an organic liquid having a density between that of graphite and that of diamond, e.g., a bromine solution or bromomethane, is used to separate the product from the raw material.

The product (diamond particulates) is then cleaned with a solvent (e.g., acetone), washed, or otherwise processed to purify, refine, etc. using accepted steps, including chemical, mechanical, vacuum filtration, or other thermal steps. The process may also include the steps of acid digestion (of unwanted substances). In addition, the materials produced hereby may be subjected to a combination of acid and oxidation agents, heated to some temperature (e.g., 120 degrees Celsius or greater) for some duration (e.g., several hours) to purify and clean the product.

FIG. 5 illustrates an exemplary process 500 for treating graphite particles in a high intensity cavitation reactor or chamber as described above.

In some embodiments, the cavitation liquid medium is altered for maximal or best effect. For example, by using an oil medium. In other embodiments the cavitation medium is a liquid metal, e.g., liquid gallium.

Those skilled in the art will appreciate the present disclosure and would understand that numerous variations on the examples provided herein are possible but covered within the present scope. The appended claims are intended to include in scope all such similar, derivative or equivalent permutations.

What is claimed is:

1. A method for processing carbon based particulates, comprising:
preparing a quantity of carbon based particulates for processing;
combining said carbon based particulates and a liquid cavitation medium;
introducing a combination of said carbon based particulates and liquid cavitation medium into a cavitation reactor chamber;
pressurizing said cavitation reactor chamber to a static fluid pressure greater than ambient atmospheric pressure;
causing cavitation in said cavitation reactor chamber so as to cause said carbon based particles to be transformed to a diamond product;
extracting said diamond product from said cavitation reactor chamber; and
post-processing said extracted diamond product.

2. The method of claim 1, said step of introducing the combination of said carbon based particulates and said liquid cavitation medium comprising placing the combination into a spherically shaped acoustic resonator.

3. The method of claim 1, said step of introducing the combination of said carbon based particulates and said liquid cavitation medium comprising introducing the combination into a cavitation reactor that is in turn placed into an acoustic resonator.

4. The method of claim 1, said post-processing comprising any of: filtration, acid bath treatment, acetone washing, and heating.

5. The method of claim 1, said post processing including a step of density sorting of said extracted diamond product using a liquid having a density intermediate between that of a purified diamond product and an impurity mixed therewith.

6. The method of claim 5, said liquid comprising a bromine solution.
